(19) United States
(12) Patent Application Publication
(10) Pub. No.: US 2011/0040623 A1
(43) Pub. Date: Feb. 17, 2011

(54) SYSTEMS AND METHODS TO IDENTIFY USERS ACCESSING A WEB PAGE

(76) Inventors: Bart Lauwers, Austin, TX (US); Kurt Briers, Bunsbeek (BE); Filip Lauweres, Erpe-Mere (BE); Michael Vaes, Zepperen (BE)

Correspondence Address: BUCKLEY, MASCHOFF & TALWALKAR LLC, 50 LOCUST AVENUE, NEW CANAAN, CT, 06840, US

(21) Appl. No.: 12/541,351

(22) Filed: Aug. 14, 2009

(51) Int. Cl. G06Q 30/00; G06F 17/30; G06F 7/06

(52) U.S. Cl. 705/14.53; 707/E17.014; 707/E17.045

(57) ABSTRACT

According to some embodiments, it may be determined, at an identification engine, that a first access of a web site is being established via a first connection between a web server and a remote device of a user. Information about the first connection may then be stored at the identification engine. It may also be determined, at the identification engine, that a second access of a second web site is being established via a second connection between a second web server and the remote device of the user. Information about the second connection may be compared, at the identification engine, with the stored information about the first connection. Based on said comparing, the second connection may be associated with the first connection.

### FIELD

The present invention relates to systems and methods to identify users accessing a web page. In particular, some embodiments of the present invention relate to systems and methods that can identify when a user returns to a web page he or she had previously visited.

### BACKGROUND

Content providers and advertisers may be interested in knowing when a particular user returns to a particular web site. For example, car company might be interested in knowing that a particular user has visited a web page associated with a new car model five times in the last week (e.g., because the car company might infer that he or she is extremely interested in that car model thus be interested in any special deals or offers that may be available in connection with that model). Similarly, content providers and advertisers may be interested in knowing when a particular user who had previously visited a first web site is now visiting a second web site (e.g., where the second web site is perhaps related to the web site). For example, a user who has visited a first type of web site might be presented with information that is selected and/or tailor for him or her when visiting a second web site. In some cases, one type of advertisement might be displayed to a user who had previously visited sports related web pages and another type of advertisement might be displayed to a user who had previously visited web pages associated with fashion clothing and jewelry.

One way of determining when a user is returning to a particular web page is to store a tracking “cookie” file on the user's machine. The cookie file may include, for example, a short string of text that is stored on the user's computer by a web browser. A cookie might consist of one or more name-value pairs containing bits of information such as user preferences, shopping cart contents, the identifier of a server-based session, and/or other data used by websites. It may be sent as a Hyper-Text Transfer Protocol header by a web server to a web client (e.g., a browser) and then sent back unchanged by the client each time it accesses that server. A cookie might be used for authenticating, session tracking (state maintenance), and/or maintaining specific information about users, such as site preferences or the contents of their electronic shopping carts. For example, when a user first visits a web page, the web server might arrange for a cookie to be stored on his or her Personal Computer (PC). The next day, when the user again visits that web page, the web server can view to the contents of the cookie and realize that the visitor is actually the same user who viewed the web page yesterday. In this way, the user's interaction with the web page (and perhaps other, related web pages) may be tracked.

Some users, however, may be uncomfortable with the idea of allowing a web site to store cookies on his or her device and/or with the idea that a web site is able to track his or her visits to web pages. For example, a user might have privacy concerns and/or be worried about security issues associated with cookies. As a result, many users disable or block the creation of cookies on their devices. Thus, web sites may find themselves unable to determine when those users return to a web site or visit related web sites.

### BRIEF DESCRIPTION OF THE DRAWINGS

FIG. 1 is a block diagram overview of a system.

FIG. 2 is a block diagram overview of a system in accordance with some embodiments of the present invention.

FIG. 3 is a flow chart of a method according to some embodiments of the present invention.

FIG. 4 is a block diagram overview of a system according to another embodiment of the present invention.

FIG. 5 is a block diagram overview of an identification engine according to some embodiments of the present invention.

FIG. 6 is a tabular representation of a portion of a lookup table in accordance with some embodiments of the present invention.

### DETAILED DESCRIPTION

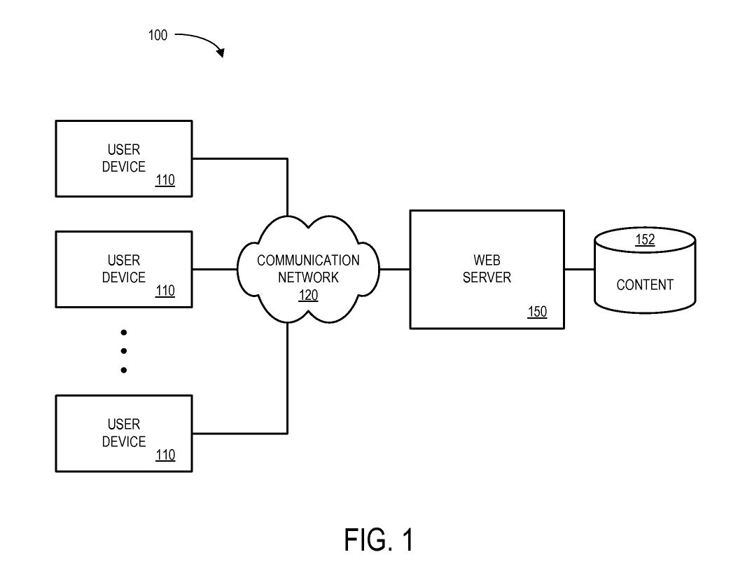

FIG. 1 is a block diagram overview of a system 100 wherein a user may access information via a communication network 120. In this case, a user might enter a web address or select a web link via a user device 110, such as a PC. The user device 110 may then communicate with a web server 150 via a communication network 120. The web server 150 might be associated with, for example, a web page or site accessed via the Internet.

As used herein, devices (such as the user devices 110 and the web server 150) may communicate via the communication network 120, such as a Local Area Network (LAN), a Metropolitan Area Network (MAN), a Wide Area Network (WAN), a proprietary network, a Public Switched Telephone Network (PSTN), a Wireless Application Protocol (WAP) network, a cable television network, or an Internet Protocol (IP) network such as the Internet, an intranet or an extranet. Note that the devices shown in FIG. 1 need not be in constant communication. For example, the user device 110 may only communicate with the web server 150 on an as-needed basis. In some embodiments, for example, the user device 110 may be a PC that intermittently utilizes a dial-up connection to the Internet via an Internet Service Provider (ISP). In other embodiments the user device 110 may be in constant and/or high-speed communication with the web server 150 through the use of any known or available connection device such as a cable or Digital Subscriber Line (DSL) modem. According to some embodiments, the communication network 120 may be or include multiple networks of varying types, configurations, sizes, and/or functionalities.

Although a single web server 150 is illustrated in FIG. 1, any number of such devices may be included in the system 100. Similarly, any number of the other devices described herein may be included in the system 100 according to embodiments of the present invention. A web server 150 may, for example, be in communication with multiple user devices 110. In some embodiments, multiple web servers 150 and/or related devices may provide various information such as advertisements and/or web pages stored in a content database 152 to one or more user devices 110.

The user device 110 and the web server 150 may be any devices capable of performing various functions described herein. The user device 110 may be, for example: a PC, a portable computing device such as a Personal Digital Assistant (PDA), an interactive television device, or any other appropriate storage and/or communication device. The web server 150 may be, for example, a web server that provides web pages for a browser application of the user device 110 (e.g., the INTERNET EXPLORER® browser application available from MICROSOFT®).

Content providers and advertisers may be interested in knowing when a particular user or user device 110 returns to a particular web site or server 150. For example, car company might be interested in knowing that a particular user has visited a web page associated with a new car model five times in the last week. Similarly, parties associated with information in the content database 152, such as advertisers, may be interested in knowing when a particular user who had previously visited a first web site is now visiting a second web site. For example, a user who has visited a first type of web site might be presented with information that is selected and/or tailor for him or her when visiting a second web site.

One way of determining when a user is returning to a particular web page is to have the web server 150 store a tracking cookie file on the user device 110. For example, when a user first visits a web page, the web server 150 might arrange for a cookie to be stored on his or her user device 110. The next day, when the user again visits that web page, the web server 150 can view to the contents of the cookie and realize that the visitor is actually the same user who viewed the web page yesterday. That is, the subsequent requests and visits of a visitor on a web site are sometimes identified by placing a unique cookie in the client browser.

Some users, however, may be uncomfortable with the idea of allowing a web server 150 to store cookies on his or her device 110 and/or with the idea that a web site is able to track his or her visits to web pages. For example, a user might have privacy concerns and/or be worried about security issues associated with cookies. Moreover, not all browsers are configured to store cookies, which may causes serious problems in web analytics and visitor profiling. For example, when a browser doesn't accept cookies, each request made by this visitor might be counted as a new visitor and a new visit, which may result in poor marketing decisions because the number of visitors measured doesn't match the real number of visitors. In addition, the content from the content database 152 provided will not take the previous interest of the visitor into account, which may result in a poor surfing experience for the visitor.

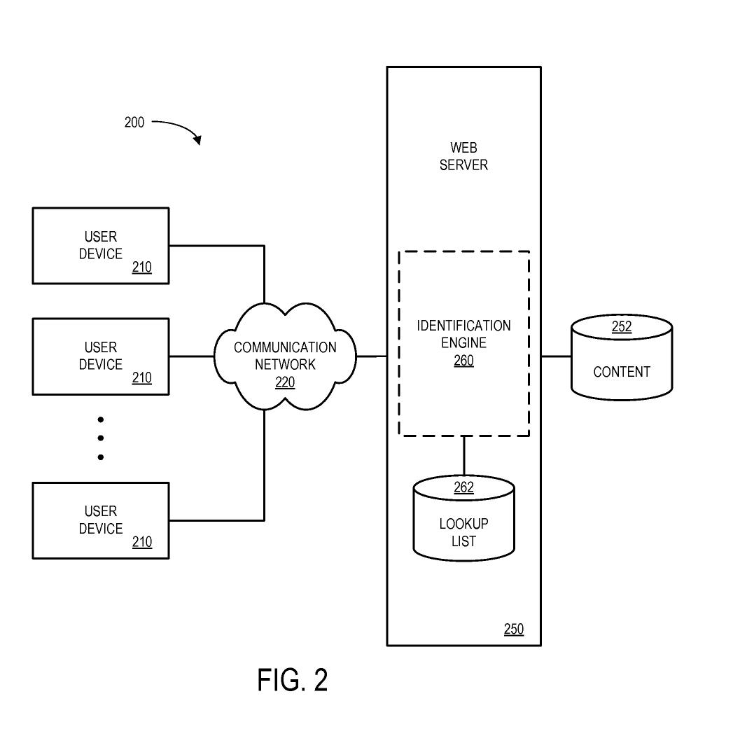

To address such issues, FIG. 2 is a block diagram overview of a system 200 in accordance with some embodiments of the present invention. As before, a user might enter a web address or select a web link via a user device 210, such as a PC. The user device 210 may then communicate with a web server 250 via a communication network 220. The web server 250 might be associated with, for example, a web page or site accessed via the Internet.

Although a single web server 250 is illustrated in FIG. 2, any number of such devices may be included in the system 200. Similarly, any number of the other devices described herein may be included in the system 200 according to embodiments of the present invention. A web server 250 may, for example, be in communication with multiple user devices 210. In some embodiments, multiple web servers 250 and/or related devices may provide various information such as advertisements and/or web pages stored in one or more content databases 252 to one or more user devices 210.

The user device 210 and the web server 250 may be any devices capable of performing various functions described herein. The user device 210 may be, for example: a PC, a portable computing device such as a PDA, an interactive television device, a wireless telephone, or any other appropriate storage and/or communication device. The web server 250 may be, for example, a web server that provides web pages for a browser application of the user device 210 (e.g., the INTERNET EXPLORER® browser application available from MICROSOFT®).

Content providers and advertisers may be interested in knowing when a particular user or user device 210 returns to a particular web site or server 250. Similarly, parties associated with information in the content database 252, such as advertisers, may be interested in knowing when a particular user who had previously visited a first web site is now visiting a second web site. For example, a user who has visited a first type of web site might be presented with information that is selected and/or tailor for him or her when visiting a second web site. Note that the information stored in the content database 252 may be associated with text, images, video, audio information, executable information, and/or pointers to other storage databases.

According to some embodiments, an identification engine 260 may be provided such that content providers and advertisers may determine when a particular user or user device 210 returns to a particular web site or server 250. The identification engine 260 may comprise, for example, hardware device, a software application, or any combination of hardware and software elements. According to some embodiments, the identification engine 260 may store information into and/or retrieve information from a lookup list 262.

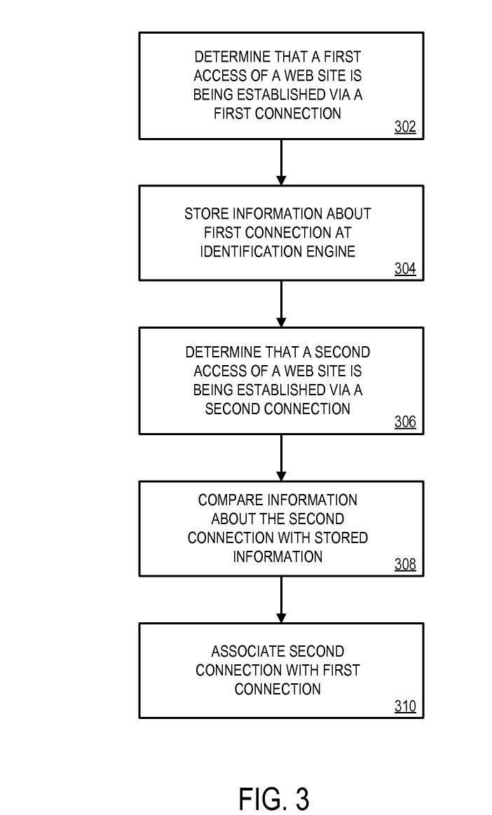

The identification engine 260 may, for example, provide a solution to the problems described herein by using a visitor identification which doesn't rely on the browsers' built in cookie mechanism. For example, FIG. 3 is a flow chart of a method that may be associated with the identification engine 260 according to some embodiments of the present invention. The flow charts described herein do not necessarily imply a fixed order to the actions, and embodiments may be performed in any order that is practicable. Note that any of the methods described herein may be performed by hardware, software (microcode), or any combination of these approaches. For example, a storage medium may store thereon instructions that when executed by a machine result in performance according to any of the embodiments described herein.

At 302, it may be determined, at an identification engine, that a first access of a web site is being established via a first connection between a web server and a remote device of a user. In some cases, the first web site may be associated with a web address entered or selected by a user via a browser application. Note that the identification engine may be located at the web server or be remote from the web server and/or the remote device of the user.

At 304, information about the first connection may be stored at the identification engine. For example, information about the first connection might be stored in a lookup list and may include collected Hyper-Text Transfer Protocol (HTTP) parameters or collected Transfer Control Protocol/Internet Protocol (TCP/IP) parameters. According to some embodiments, the storing of information about the first connection at the identification engine comprises generating a first “hash string” by combining the collected parameters. The hash string may act, for example, as a “fingerprint” that can be used to later identify that particular user or user device. Moreover, the storing of information about the first connection at the identification engine might further include storing the first hash along with a timestamp associated with the last occurrence of this string in a lookup list.

Note that according to some embodiments, the lookup list may be maintained in-memory. According to other embodiments, the lookup list may be stored and/or maintained in a relational database.

At 306, it is determined, at the identification engine, that a second access of a second web site is being established via a second connection between a second web server and the remote device of the user Note that any of the determinations described herein may be performed by a machine and may be substantially “automatic” (e.g., performed with little or no human intervention). Moreover, note that a number of different remote devices might be associated with a single user (e.g., a PC, game console, and wireless telephone may all be associated with a single user). Similarly, a single remote device might be associated with many different users (e.g., a set-top box might be associated with various family members). Note that the determination that the second access of the second web site is being established might include generating a second hash string by combining collected parameters associated with the second access. Moreover, it may further include using the second hash string to locate the first hash string in a lookup list.

At 308, information about the second connection is compared, at the identification engine, with the stored information about the first connection. Based on said comparing, the second connection may be associated with the first connection at 310. The associating may comprise, for example, a realization that the second connection is being established by the same person who (or device that) made the first connection.

According to some embodiments, based on the association between the second connection and the first connection, a selection of advertising information to be provided along with the second web site may be facilitated. The “advertising information” might comprise, for example, text or graphics associated with the first connection. Note that, according some embodiments, the second web site is the same as the first web site and the second web server is the same as the first web server. According to other embodiments, the second web site is different than the first web site and the second web server is different than the first web server. This selection of the advertising information may further based on supplemental information stored at the identification engine in association with at least one of: (i) the user or (ii) the remote device.

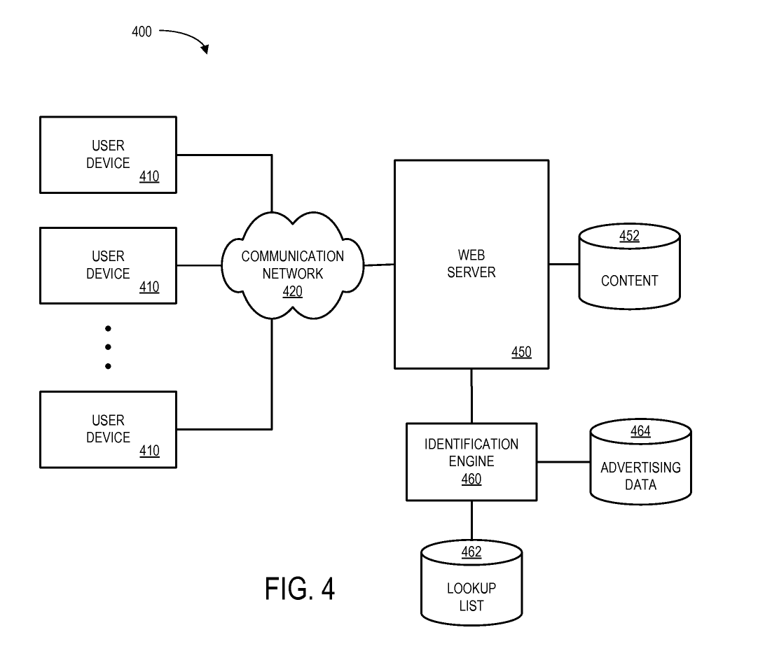

Note that the system of FIG. 2 and the method of FIG. 3 are provided only as illustrations and other systems and methods may be utilized in accordance with various embodiments of the present invention. For example, FIG. 4 is a block diagram overview of a system 400 according to another embodiment of the present invention. As before, a user might enter a web address or select a web link via a user device 410, such as a PC. The user device 410 may then communicate with a web server 450 via a communication network 420. The web server 450 might be associated with, for example, a web page or site accessed via the Internet.

Although a single web server 450 is illustrated in FIG. 4, any number of such devices may be included in the system 400. Similarly, any number of the other devices described herein may be included in the system 400 according to embodiments of the present invention. A web server 450 may, for example, be in communication with multiple user devices 410. In some embodiments, multiple web servers 450 and/or related devices may provide various information such as advertisements and/or web pages stored in one or more content databases 452, 464 to one or more user devices 410.

The user device 410 and the web server 450 may be any devices capable of performing various functions described herein. The user device 410 may be, for example: a PC, a portable computing device such as a PDA, an interactive television device, a wireless telephone, or any other appropriate storage and/or communication device. The web server 450 may be, for example, a web server that provides web pages for a browser application of the user device 410 (e.g., the INTERNET EXPLORER® browser application available from MICROSOFT®).

Content providers and advertisers may be interested in knowing when a particular user or user device 410 returns to a particular web site or server 450. Similarly, parties associated with information in the content databases 452, 464, such as advertisers, may be interested in knowing when a particular user who had previously visited a first web site is now visiting a second web site. For example, a user who has visited a first type of web site might be presented with information that is selected and/or tailor for him or her when visiting a second web site. Note that the information stored in the content databases 452, 464 may be associated with text, images, video, audio information, executable information, and/or pointers to other storage databases.

According to some embodiments, an identification engine 460 may be provided (e.g., remote from the web server and/or in connection with many different web servers) such that content providers and advertisers may determine when a particular user or user device 410 returns to a particular web page, site, or server 450. The identification engine 460 may comprise, for example, hardware device, a software application, or any combination of hardware and software elements. According to some embodiments, the identification engine 460 may store information into and/or retrieve information from a lookup list 462. Moreover, the identification server 464 may access advertising data 464 not directed related to the content 452 provided by the web server 450.

The identification engine 460 may, for example, provide a solution to the problems described herein by using a visitor identification which doesn't rely on the browsers' built in cookie mechanism.

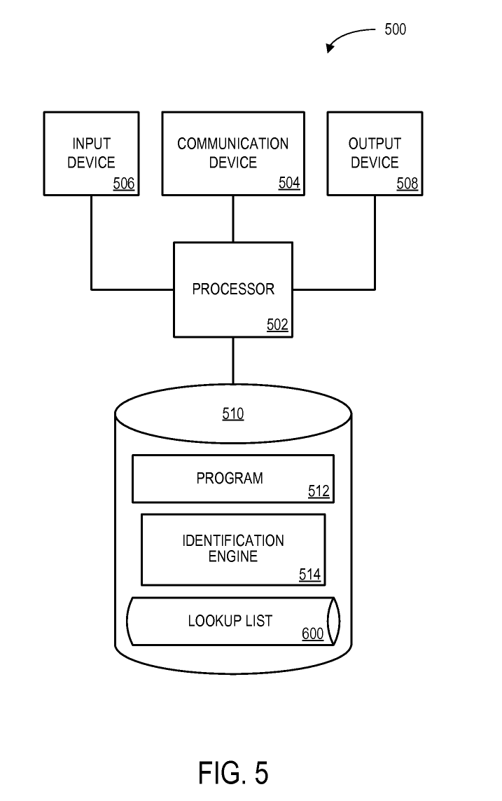

FIG. 5 is a block diagram overview of an identification engine 500 according to some embodiments of the present invention. The identification engine 500 may be, for example, descriptive of the devices shown in FIG. 2 or 4. The identification engine 500 comprises a processor 510, such as one or more INTEL® Pentium® processors, coupled to a communication device 520 configured to communicate via a communication network (not shown in FIG. 5). The communication device 520 may be used to communicate, for example, with one or more user devices 210, 410. The identification engine 500 further includes an input device 540 (e.g., a mouser and/or keyboard to enter advertisement selection rules) and an output device 550 (e.g., a computer monitor to display identification results).

The processor 510 communicates with a storage device 530. The storage device 530 may comprise any appropriate information storage device, including combinations of magnetic storage devices (e.g., a hard disk drive), optical storage devices, and/or semiconductor memory devices such as Random Access Memory (RAM) devices and Read Only Memory (ROM) devices.

The storage device 530 stores a program 512 and/or identification engine application 514 for controlling the processor 510. The processor 510 performs instructions of the programs 512, 514, and thereby operates in accordance with any of the embodiments described herein. For example, the processor 510 may determine that a first access of a web site is being established via a first connection between a web server and a remote device of a user. The processor 510 may also store information about the first connection at the identification engine (e.g., in a lookup list 600) and determine that a second access of a second web site is being established via a second connection between a second web server and the remote device of the user. The processor 510 may then compare information about the second connection with the stored information about the first connection and, based on the comparing, associate the second connection with the first connection.

The programs 512, 514 may be stored in a compressed, uncompiled and/or encrypted format. The programs 512, 514 may furthermore include other program elements, such as an operating system, a database management system, and/or device drivers used by the processor 510 to interface with peripheral devices.

As used herein, information may be “received” by or “transmitted” to, for example: (i) the identification engine 500 from another device; or (ii) a software application or module within the identification engine 500 from another software application, module, or any other source.

According to some embodiments, in addition to web fingerprint information, advertising information may be selected based on: (i) user information (e.g., his or her demographic information), (ii) web page information, (iii) a business type, (iv) advertising campaign information, (v) time information (e.g., a time of day or holiday season), and/or (vi) geographic information.

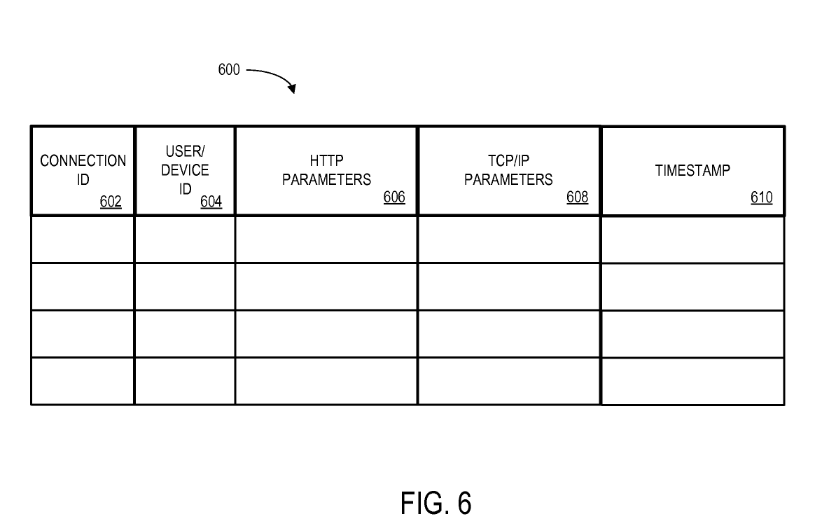

In some embodiments (such as shown in FIG. 5), the storage device 510 stores a lookup list 600 to facilitate the tracking of visitors to web pages. One example of a database 600 that may be used in connection with the identification engine 500 will now be described in detail with respect to FIG. 6.

Referring to FIG. 6, a table is shown that represents the lookup list 600 that may be stored at the identification engine 500 according to some embodiments. The table may include, for example, entries identifying connection between user devices and particular web pages, sites, or servers. The table may also define fields 602, 604, 606, 608, 610 for each of the entries. The fields 602, 604, 606, 608, 610 may, according to some embodiments, specify: a connection identifier 602, a user/device identifier 604, HTTP parameters 606, TCP/IP parameters 608, and/or timestamp information 610. The information in the lookup list 600 may be created and updated, for example, based on information exchanged with remote user devices.

The connection identifier 602 may be, for example, an alphanumeric code associated with a particular user or user device (e.g., associated with the user/device identifier 604). The HTTP and TCP/IP parameters 606, 608 and timestamp information 610 may reflect the various connections values that are associated with the establishment of the connection between the user device and the web site. Note that the lookup table 600 might store other types of information in addition to, or instead of, the information illustrated in FIG. 6. For example, the lookup table 600 might store hash values generated based on the information in the lookup table 600.

Thus, some embodiments described herein may provide a solution to the problems described herein by using a visitor identification which doesn't rely on the browsers' built in cookie mechanism.

The embodiments described herein do not constitute a definition of all possible embodiments, and those skilled in the art will understand that many other embodiments may be possible and/or practicable. Further, although the embodiments are briefly described for clarity, those skilled in the art will understand how to make any changes, if necessary, to the above-described apparatus and methods to accommodate these and other embodiments and applications.

We claim:

1. A method, comprising:
determining, at an identification engine, that a first access of a web site is being established via a first connection between a web server and a remote device of a user;
storing information about the first connection at the identification engine;
determining, at the identification engine, that a second access of a second web site is being established via a second connection between a second web server and the remote device of the user;
comparing, at the identification engine, information about the second connection with the stored information about the first connection; and
based on said comparing, associating the second connection with the first connection.

2. The method of claim 1, further comprising:
based on the association between the second connection with the first connection, facilitating a selection of advertising information to be provided along with the second web site.

3. The method of claim 2, wherein the second web site is the same as the first web site and the second web server is the same as the first web server.

4. The method claim 2, wherein the second web site is different than the first web site and the second web server is different than the first web server.

5. The method of claim 2, wherein the selection of the advertising information is further based on supplemental information stored at the identification engine in association with at least one of: (i) the user, or (ii) the remote device.

6. The method of claim 2, wherein the selection of the advertising information is based at least in part on the first web site.

7. The method of claim 1, wherein the information about the first connection stored at the identification engine includes at least one of: (i) collected hypertext transfer protocol parameters, or (ii) collected transfer control protocol/internet protocol parameters.

8. The method of claim 7, wherein said storing of information about the first connection at the identification engine comprises:
generating a first hash string by combining the collected parameters.

9. The method of claim 8, wherein said storing of information about the first connection at the identification engine further comprises:
storing the first hash with the timestamp of the last occurrence of this string in a lookup list.

10. The method of claim 9, wherein the lookup list is maintained in-memory.

11. The method of claim 9, wherein the lookup list is maintained in a relational database.

12. The method of claim 9, wherein said determining that the second access of the second web site is being established includes:
generating a second hash string by combining collected parameters associated with the second access.

13. The method of claim 12, further comprising:
using the second hash string to locate the first hash string in a lookup list.

14. A system, comprising:
a communication interface;
a processor coupled to the communication interface; and
a storage device in communication with said processor and storing instructions adapted to be executed by the processor to:
determine that a first access of a web site is being established through the communication interface via a first connection between a web server and a remote device of a user,
store information about the first connection,
determine that a second access of a second web site is being established via a second connection between a second web server and the remote device of the user,
compare information about the second connection with the stored information about the first connection, and
based on said comparing, associate the second connection with the first connection.

15. The system of claim 14, further comprising:
a lookup list storage element, wherein the lookup list storage element is associated with at least one of: (i) in-memory storage, or (ii) a relational database.

16. The system of claim 14, further comprising:
an advertisement selection engine to facilitate a display of an advertisement based at least in part on the association between the first and second connections.

17. The system of claim 14, wherein the information stored about the first connection is associated with a first hash string generated by combining collected parameters.

18. A computer-readable medium storing instructions adapted to be executed by a processor to perform a method, said method comprising:
determining, at an identification engine, that a first access of a web site is being established via a first connection between a web server and a remote device of a user;
storing information about the first connection at the identification engine;
determining, at the identification engine, that a second access of a second web site is being established via a second connection between a second web server and the remote device of the user;
comparing, at the identification engine, information about the second connection with the stored information about the first connection; and
based on said comparing, associating the second connection with the first connection.

19. The computer-readable medium of claim 18, wherein execution of the instructions further results in facilitating a selection of advertising information to be provided along with the second web site based on the association between the second connection with the first connection.

20. The computer-readable medium of claim 19, wherein the selection of the advertising information is further based on supplemental information stored at the identification engine in association with at least one of: (i) the user, or (ii) the remote device.
